(19) United States
(12) Patent Application Publication
(10) Pub. No.: US 2006/0013977 A1
(43) Pub. Date: Jan. 19, 2006

(54) Polymeric ballistic material and method of making

(76) Inventors: Leslie P. Duke, Silver Creek, GA (US); Eric Hart, Woodburn, KY (US)

Correspondence Address: JOHN S. PRATT, ESQ;KILPATRICK STOCKTON, LLP, 1100 PEACHTREE STREET, ATLANTA, GA, 30309, US

(21) Appl. No.: 10/889,946

(22) Filed: Jul. 13, 2004

(51) Int. Cl. B29C 47/00

(52) U.S. Cl. 428/36.9; 428/218

(57) ABSTRACT

This invention relates to a polymeric ballistic material comprising a high molecular weight, high density polyethylene (HMW-HDPE) and/or composite, and to articles made from this ballistic material suitable for stopping projectiles. The articles may include backstops for firing ranges and home use, armor for vehicles, personnel, and aircraft, training targets, protection for temporary or mobile military and/or police installations, buildings, bunkers, pipelines or any “critical” need equipment that might require protection from ballistic impact, and the like.

### BACKGROUND OF THE INVENTION

1. Field of the Invention

This invention relates to polymeric compositions and composite materials suitable for use in ballistic applications, and articles made from these compositions and materials, particularly articles suitable for absorbing ballistic impact. The invention also relates to methods for preparing these compositions and articles.

2. Description of Related Art

Currently several types of ballistic shields are made from polyurethane polymers for transparent window shielding applications (i.e., in “bullet-proof glass”). Other ballistic materials developed in the 1970's include shields made from ceramics, and from aramid (e.g., Kevlar) fibers in various configurations. These materials have been suggested and used as lightweight armor for stopping bullets of specific design and specific velocities. Ceramic and aramid fibers have also been combined into a ballistic material. Ceramic and concrete based ballistic materials have also been used to protect personnel in armored vehicles.

The above shielding systems each have their own limitations in various aspects of design and respective physical properties. The ceramic aramid fiber composite armor is able to stop some, but not all, projectiles. Military helmets made from Kevlar or aramid fibers are best at stopping low velocity bullets or projectiles including bomb fragments, explosive debris, or deflection bullets. High velocity bullets fired from rifles are not stopped with fabric/composite systems. The subsequent result has been injurious and sometimes fatal. As a result, aramid fiber systems are considered somewhat unreliable.

Moreover, once a Kevlar or aramid fiber shield or fabric shield is compromised, e.g., by a ballistic impact, the shielding device can no longer be used, and should be discarded. The expense of replacing these armaments is extremely high, and repair is not possible. As a result, use of ballistic fiber or fabric armor in combat or training is very expensive.

Similar problems occur with ceramic armor. While some ceramic shielding is effective at stopping bullets of many sizes, powers, and/or velocities, most ceramics are quite brittle; once a round hits the ceramic shield, the shield must be replaced for fear that another encounter at a future time would provide no protection. Security of the shielded person is a constant concern, due to the fact that multiple hits may compromise the shield, and changing plates or armor may not be possible during combat.

As a result of the considerations described above, there remains a need in the art for a lightweight, inexpensive, compact, and durable protective material that will effectively absorb and disperse the energy of ballistic materials, such as bullets, slugs, sabot slugs, shrapnel, and the like.

In addition to the ballistic armors described above, other methods for stopping ballistic materials have been described. One example of such a system is described in U.S. Pat. No. 6,722,195. This system is designed for trapping and recovery of projectiles fired under highly controlled conditions, so that the striations on the projectiles and other forensic indicators can be examined. The apparatus consists of an elongated trough in which are alternating layers of fibrous material and foam. A projectile fired into the apparatus first passes through a layer of fibrous material, which partially envelops the projectile, protecting its surface and increasing its cross section as it enters the next layer, which is made of foam. The increased surface area creates friction with the foam, which slows down the projectile. If the first foam layer does not stop the projectile, it will pass through another layer of fibrous material, and the process will repeat until the projectile has stopped. The trough can then be opened and the projectile removed, in essentially the condition it was in when it left the barrel of the firearm.

While this system is quite effective, it is designed to be used in obtaining projectiles for subsequent analysis under highly controlled conditions, by skilled marksmen or forensic technicians. It is not designed or suitable for stopping projectiles under the less controlled, but more realistic and common, conditions found in a firing range, backyard, or combat. Moreover, the need to recover the projectile in pristine condition so that subsequent analysis can be performed has necessitated that the system be rather elongated. Because of the length that the projectile may have to travel before stopping, the projectile should be fired along a trajectory substantially parallel to the longitudinal axis of the trough. This requirement renders the use of the device impractical in other than controlled laboratory situations. As a result, there remains a need in the art for a material that can stop ballistic projectiles that is compact, and not particularly limited with respect to the orientation of the projectile relative to the material.

Conventional ballistic traps are also bulky and heavy, due to the large amount of material necessary to effectively stop projectiles. This can create problems, e.g., where steel or other materials are used to trap projectiles. As an example, tactical police and military training involving multistory buildings is extremely difficult. Rounds fired at targets in the upper stories of these buildings must be trapped effectively because high powered projectiles fired upward may travel significant distances and injure people or property. However, conventional ballistic traps are difficult to use above ground level because of the strain their weight places on the building structure. As a result, there remains a need in the art for a material that is relatively lightweight, and that can be used in multistory tactical training.

In addition, ballistic traps used in firing ranges generally do a poor job of containing the projectiles. Since most projectiles contain a significant amount of lead, fragmentation and ricochets can result in a significant amount of lead entering the environment, particularly at firing ranges. There remains a need in the art for a ballistic trap that can retain within it the lead from projectiles fired at it, making disposal of the lead much easier.

### SUMMARY OF THE INVENTION

This invention relates to a polymeric ballistic material comprising a high molecular weight, high density polyethylene (HMW-HDPE), and to articles made from this ballistic material suitable for stopping projectiles. The articles may include backstops for firing range and home use, armor for vehicles, personnel, and aircraft, training targets, protection for temporary or mobile military and/or police installations, buildings, bunkers, pipelines and/or any “critical need equipment that might require protection from ballistic impact, and the like.

As a projectile enters the material, its kinetic energy is converted into heat; the region in front of the projectile is compressed and melted. This molten polymer is then pumped past the projectile and forced into the region behind the projectile where it cools and hardens, with the result that the track of the projectile is of smaller diameter than the projectile itself. Moreover, because the molten region ahead of the projectile generally extends beyond the diameter of the projectile itself, the shear stress imposed by the surface of this molten polymer volume moving through the solid provides an additional sink for the kinetic energy of the projectile.

For projectiles that are spinning (e.g., projectiles fired from a rifled barrel or rifled slugs fired from a smooth bore barrel, such as a shotgun), it is believed that the energy resulting in the rotational motion of the projectile is at least partially dissipated by the shear between any projectile surface in contact with polymer, and by the pumping action that the projectile rotation exerts on the molten polymer. Rotation of the projectile effectively pumps molten polymer to the rear of the projectile, dissipating the projectile energy, and helping to slow its forward motion (in much the same way that a twist drill ceases to penetrate a wood block when it stops rotating).

Desirably, the polymeric material contains at least one density gradient at an angle to the projectile path. Without wishing to be bound by theory, it is believed that the difference in density across the projectile results in a difference in coefficient of friction across the projectile cross section. As the projectile moves through this region of differential density, the differences in coefficient of friction causes the polymer to exert different frictional forces across the projectile. The aspect ratio of the projectile with respect to its path through the material increases, drastically increasing the energy transfer between the projectile and the material. The sooner that this change in aspect ratio (“tumbling”) begins to occur, the more rapidly the projectile will be stopped and captured by the material or apparatus.

In particular embodiments, the invention relates to a ballistic apparatus having at least one layer of extruded polymeric material containing HMW-HDPE. In a particular form of this embodiment, the extruded polymeric material is wound into a coil or disk. Multiple coils or discs can be bonded together, increasing the thickness of the apparatus. Moreover, in a particular embodiment, one or more coils or discs of relatively high density material can be encased within or between layers of a lower density material, forming a composite structure.

In other embodiments, the ballistic apparatus of the invention can be used as a firearm backstop, e.g., at a firing range or live-fire training facility. In another embodiment of the invention, the ballistic apparatus can be used a protective ballistic armor by disposing it adjacent to the structure to be protected. Non limiting exemplary structures include personnel, building structures, ground vehicles, aircraft, spacecraft, ships, and pipelines.

### BRIEF DESCRIPTION OF THE DRAWINGS

FIG. 1 is a schematic view of a portion of one embodiment of a ballistic apparatus according to the invention, illustrating the liquification of polymer and pumping of the liquefied polymer material in the region of the projectile path.

FIG. 2 is a schematic view of a coil or disc of polymeric material according to one embodiment of the invention.

FIG. 3 is a schematic cross sectional view of one embodiment of a ballistic apparatus of the invention.

FIG. 4 is a schematic cross sectional view of another embodiment of a ballistic apparatus of the invention having differing thickness lower density portions.

FIG. 5 is a schematic cross sectional view of another embodiment of a ballistic apparatus of the invention having a plurality of layers of different composition.

### DETAILED DESCRIPTION OF SPECIFIC EMBODIMENTS

After an extensive investigation and testing it was discovered that a particular type of polyethylene proved a suitable shielding material for stopping and retaining high velocity projectiles, including those fired from handguns, rifles, and shotguns, as well as shrapnel. The polymer is a thermoplastic, HMW-HDPE having impact resistance and melt flow properties sufficient to absorb the energy from a wide range of projectiles, including those fired from handguns, e.g. .22, .357 magnum, .45, and .50 calibers, as well as 7 mm Tokarev and 9 mm Luger rounds. Rifle and shotgun rounds tested included those fired from an AR-15 or M-16 assault rifle (.223 caliber, 5.56 mm), an AK-47 assault rifle (7.62 mm), 12 gauge buckshot loads, 12 gauge rifled slugs, and 12 gauge sabot slugs.

The bulk polymer's resistance to impact and melt flow was sufficient to absorb the energy of all types of incoming projectiles. Desirably, the polymer is extruded or otherwise oriented in a direction substantially perpendicular to the expected trajectory of the projectile. Ballistic apparatus incorporating the polymeric material have been designed according to the invention to increase the likelihood of such an orientation, even for low angle projectiles. High velocity projectiles are stopped when they enter perpendicular to the direction of orientation of the thermoplastic polymer.

As the literature indicates, the high molecular weight polyethylene polymers have the ability to orient their polymeric chains without crystallization, due to entanglement of the polymer chains. This is not true of low molecular weight HDPE (LMW-HDPE). Low molecular weight HDPE can be drawn six to twenty times its normal elongation, while high molecular weight HDPE can draw only one to four times its normal elongation without breaking. However, low molecular weight HDPE is brittle to sudden impact. Without wishing to be bound by any theory, it is believed that when low molecular weight HDPE cools, its shorter chains experience less entanglement, allowing this form of HDPE to solidify from an essentially amorphous or liquid melt into distinct, highly packed and oriented phases. In these zones or phases, the polymer crystallizes in a manner similar to that of a micro-crystalline wax. Because low molecular weight HDPE contains a high population of crystalline zones, it provides a more brittle matrix. This brittleness is generally not observable at room temperature under normal conditions, but can lead to stress cracking easily at low temperatures or under sudden impact.

High molecular HDPE is so entangled with long chains that crystallinity is minimized. In general, the characterization of HMW-HDPE and LMW-HDPE classifies LMW-HDPE as an HDPE with a molecular weight between about 2.5×10⁵ and about 8.0×10⁵ Daltons. HDPE's with molecular weights below these values are too crystalline and brittle for use in ballistic materials and shatter on ballistic impact. HDPE's with molecular weights in or above the 10⁶ to 10⁷ Dalton range are classified as HMW-HDPE. At these molecular weights, the HDPE is believed to become more amorphous in nature and its crystallinity is minimized. The resulting material is an extremely tough thermoplastic material, which can be viewed as having elastomeric properties. Exemplary suitable HMW-HDPE materials include, but are not limited to, Exxon HMW HDPE, Huntsman Chemical HMW HDPE, BP HMW HDPE, and Equistar, L4912; L5906. Other HMW-HDPE materials having properties described above are also suitable for use in this invention, including reground scrap HMW-HDPE, etc.

While both types of HDPE are formed using similar processes, chain extension in HMW-HDPE is usually achieved by chemistries involving metallocene catalysis. The crystallinity of the HMW-HDPE is minimized by a relatively high level of chain entanglement, which prevents the polymer chains from sufficiently aligning in three dimensions to form appreciable crystallinity.

Because of its different structure, HMW-HDPE exhibits different polymer dynamics than other HDPE. It does not flow very well at its intrinsic melt temperature, but instead congeals into a rubbery mass, having an elasticity similar to that of a rubber ball. It is difficult to orient at low temperatures without breaking during the draw down process. HMW-HDPE appears to have lost its crystalline properties and resembles a frozen liquid or amorphous gel, much like a vulcanized elastomer. Since crystallinity is restricted by long polymeric chains, only slight dispersions of microcrystallites are possible. Its melt viscosity is very high; consequently the pressure to move or pump it is over 1600-2000 psi. at 450° F.

However, when super heated, HMW-HDPE will become fluid and can be made to flow to some degree. This is what occurs when a high velocity projectile strikes the polymer. When the polymer is pulled or stretched in this super heated state, it will cool quickly, and revert to its congealed state. As a result, the cooling polymer acts like an extremely aggressive adhesive with respect to anything it contacts, such as a spinning projectile. This adhesion can be promoted by using a maleated HDPE and compatible adhesion promoting agents, such as polyethylene acrylic acid.

As it cools, the polymeric material attempts to return to its original position. Ballistic apparatus made with the polymeric material were observed to prevent projectiles from penetrating more than an inch or so; some were forced back toward the surface of the apparatus and ejected from it entirely by the restoring force of the cooling polymer. When projectiles penetrated further, the initial hole of entry closes very rapidly, trapping the bullet in the apparatus. This is especially true when the apparatus contains a layer of HMW-HDPE foam at the surface, and a higher density HMW-HDPE material near the core. Because of the energy absorbing properties of the polymeric material, the change in density along the projectile trajectory through the material, and the expansion of the polymeric material as it cools, the projectile is truly captured by the apparatus with no chance of escape, and stops within a short distance.

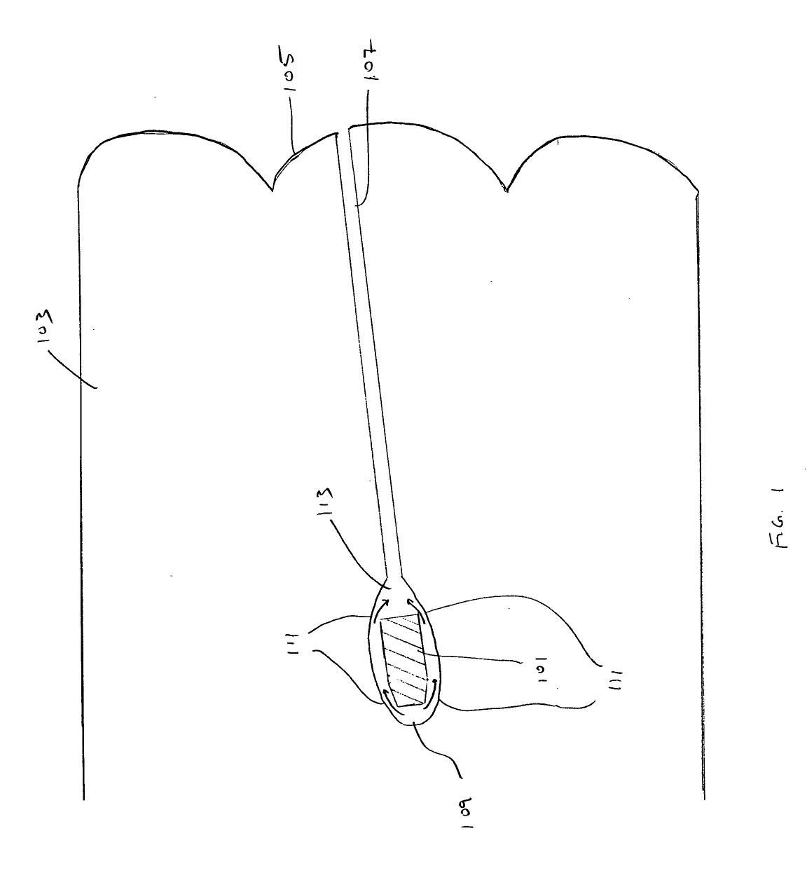

The behavior of the polymeric material of the invention when subjected to projectile impact is schematically illustrated in FIG. 1. Projectile 101 has penetrated polymeric material 103 by impacting curved surface 105 and traveling along path 107 into the material. A compression zone 109 approximately forward of the front end of the projectile 101 substantially liquefies the polymeric material in front of the projectile. The forward motion of the projectile, combined with any spin of the projectile about its longitudinal axis will pump the liquefied polymer along the sides of the projectile, as indicated by arrows 111, into a rear solidification zone 113, where the liquefied polymer collects and hardens, narrowing the track of the projectile to a diameter smaller than that of the projectile itself.

Table 1 below shows experimentally determined penetration depths for various caliber projectiles fired into the HMW-HDPE material of the invention.

TABLE 1
Experimental Firings

| | Penetration (in.) |
|---|---|
| Hand Guns | |
| 357 Mag. | 1-1.3 |
| .22 Cal. | 0-.25 |
| .45 Cal. | .25-.50 |
| 9 mm | .75-1.25 |
| Rifles (High Powered) | |
| AK-47 | 5.75-11.00 |
| M16 | 5.00-8.00 |

The change in density along the projectile trajectory provides an important and advantageous feature to the apparatus of the invention. The change in density causes a change in aspect ratio (or tumbling), which rapidly increases the energy dissipation of the projectile; the sooner the projectile tumbles, the shorter the distance required to capture it.

As part of the invention, it has been discovered and observed that as the degree of orientation of the polymer strands in the material is increased, the curvature of the trajectory of the projectile in the polymer increases as well. Without wishing to be bound by theory, it is believed that this effect results in part because the spin of the bullet biased its forward direction to a certain degree as it encountered each fiber. Hence, as the bullet encounters more fibers, it turns, changing its aspect ratio relative to the orientation of the fibers, until eventually it either stops or begins to tumble.

It has also been discovered that if the density of the polymer changes significantly, then the bullet changes direction and travels toward a lower density zone. When this occurs, the bullet begins to tumble. When the bullet left a higher density zone and entered a lower density zone, the bullet became unstable resulting in tumbling or curved trajectory. In all events the polymer absorbed the kinetic energy of the projectile and converted it into heat that was observed as melted polymer and/or a general warming of the polymer mass.

It was also observed that low velocity projectiles (and in particular, low angle low velocity bullets) bounce or ricochet off of the material if the surface density was too high, e.g., around 0.95 to 1.5 g/cc or higher. Accordingly, it is generally desirable to use a material having a density at the surface of between about 0.2 g/cc and about 1.5 g/cc (for a filled material). Densities that are lower (below about 0.2 g/cc), while still usable, increase the risk that high powered projectiles can penetrate through the material, and are therefore not recommended unless the material will only be subjected to low velocity projectiles, and unless the material is particularly thick (e.g., has a thickness ranging from around 6 to around 20 inches, which may not be cost effective or efficient).

This density can be controlled at the time of manufacturing by incorporating exothermic blowing agents, endothermic blowing agents, or a mixture of these. The concentration of blowing agent necessary will depend somewhat on the temperature and pressure of the extruder. For example, incorporation of about 0.5 pph FOAMAZOL 50 or FOAMAZOL 81 (Bergen Intl.) blowing agent into an extruder running at blowing set temperature of about 400° F. will provide an open cell foam having a density of about 0.86 g/cc; operating the same extruder at a temperature of about 385° F. provides a closed cell foam having a density of about 0.6 g/cc. Other suitable blowing agents include calcium hydroxide, and citric acid—sodium bicarbonate (HYDROSEROL). Density can also be controlled by addition of filler materials. These can be fibers or particulates that are wetted for incorporation into the polymeric material (e.g., fillers treated with wetting agents such as Amplify 204 (Dow Chemical), or silane- or titanate-treated fillers) can be coupled efficiently to the polymeric material. These fillers also provide a more uniform melt viscosity.

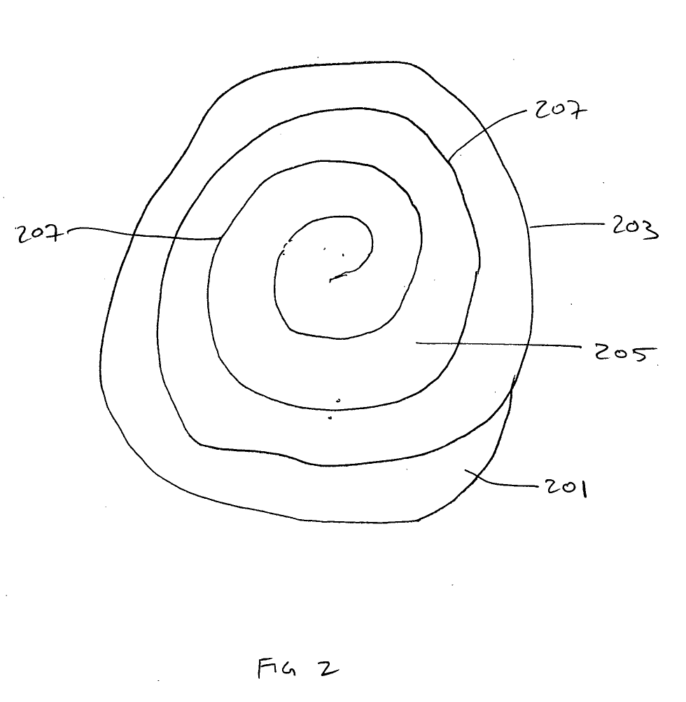

For higher velocity projectiles, higher densities are required to slow down and stop the projectile. However, high velocity projectiles striking a high density surface can deflect or ricochet, as described above. Several features of certain embodiments of the ballistic material of the invention help to avoid this occurrence. First, orientation of the projectile trajectory to the material surface is desirably at a relatively high angle (perpendicular, if possible). This helps to increase the likelihood of capture of the projectile by the material, and begins the process of changing the projectile aspect ratio very quickly. Since projectiles are likely to contact the material from a variety of angles relative to the overall plane of the material, certain embodiments of the invention include a material surface that is not flat, but is wavy and varying, as shown by surface 105 in FIG. 1. One method for achieving this profile is to extrude the polymeric material in the form of a tube 201, and wind the tube into a spiral plate 203 whose faces 205 form the surfaces that contact the projectile, as illustrated schematically in FIG. 2. The surfaces of tube 201 come into contact as the spiral is wound, forming higher density regions 207. The repeated curvature of the surface of the face of the material increase the likelihood that even a projectile traveling at a low angle with respect to the plane of the material will contact the surface at a high angle, increasing the likelihood of capture, and decreasing the likelihood of ricochet.

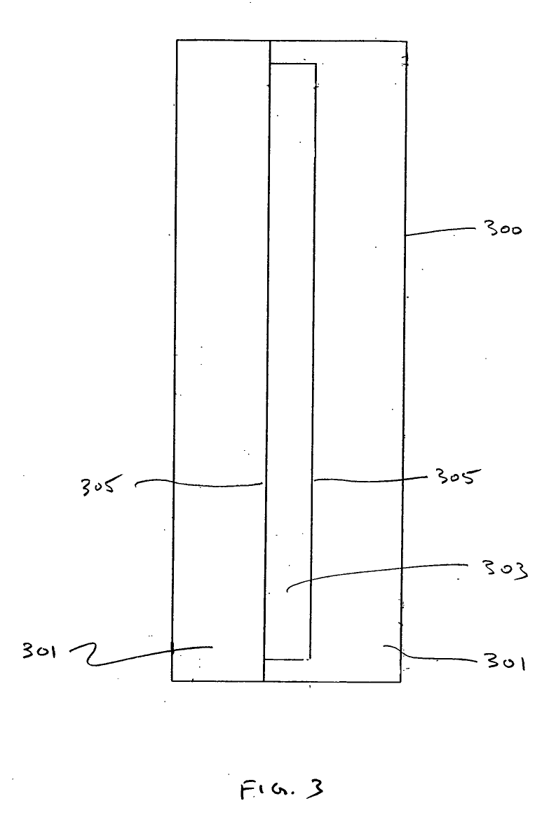

In addition to the repeated curved surface, capture of the projectile can be enhanced by providing a comparatively low density jacket or shell around a comparatively high density core. A cross sectional schematic of one embodiment of such an apparatus 300 is shown in FIG. 3. The lower density jacket 301 may be the same polymeric composition as the higher density core area or “hard plate” 303, but more highly foamed. Alternatively, two different polymeric formulations of different density may be joined together, with the lower density polymer disposed toward the projectile trajectory. The outer layer of less dense polymer 301 ensures that the projectile is trapped, while the density change from the outer material to the inner material significantly changes the projectile's aspect ratio with respect to the oriented polymer.

Moreover, the interface 305 between the high density and low density material can act as an accumulation zone for projectiles absorbed by the apparatus. Either or both layers may contain additional density gradients within them that help to change the aspect ratio of the projectile and trigger tumbling. Tumbling causes the projectile to transfer energy much more efficiently to the polymer mass, resulting in a more rapidly captured projectile. Whether bullets are high or low velocity, deformation occurs to the bullet with full metal jackets, while All bullets made entirely of lead (unjacketed) were deformed or totally destroyed.

The hard plate/foamed jacket construction provides excellent density gradient for initiating tumbling of the projectile, and can be constructed to provide an accumulation zone for projectile material as described above. The hard plate as described above can be high density HMW HDPE with a typical density of 0.86 g/cc to 0.965 g/cc (with no fillers). The inclusion of fillers can increase the density of the hard plate to 1.4 g/cc or more. However the hard plate can also be a ceramic or metal material in order to obtain even higher densities, if desired for particular uses. The configuration of the hard plate can be varied by installing a steel ballistic plate or block of steel within the apparatus having a particular desired shape or orientation. The hard plate can also be perforated, even to the point of using a heavy duty mesh that can be set in the mold to be surrounded by HMW HDPE and/or other composite material. These heavily reinforced apparatus can be used in fortifications in walls, large shields for armored vehicles, bulkheads, pipelines, pump stations, and the like to protect them from attack by explosive devices, gunfire, artillery, etc.

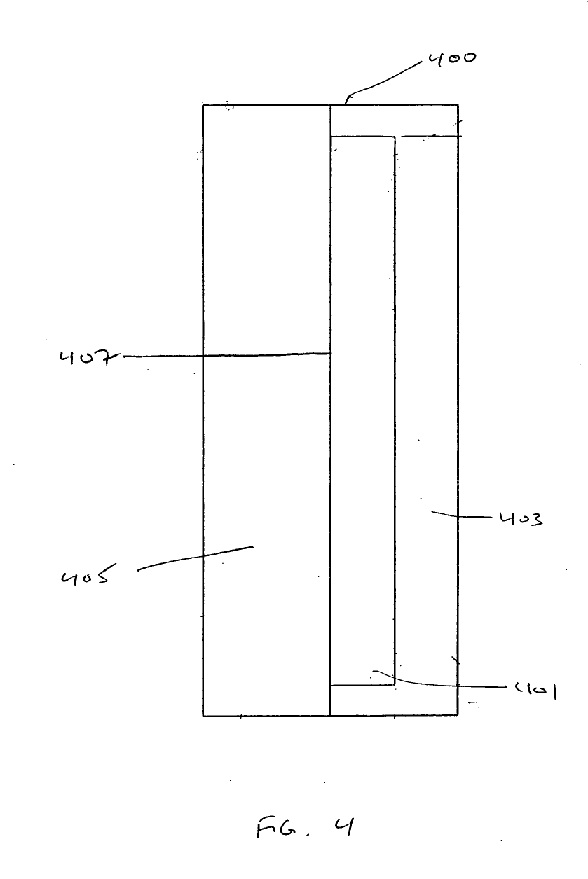

The embodiment shown in FIG. 3 is reversible as illustrated, as both layers of foam are shown to have the same thickness. However, it is also possible to make a ballistic apparatus that is not reversible, but that has a thicker lower density layer on one side, in order to provide even more effective capture of projectiles. Such a ballistic apparatus 400 is illustrated schematically in cross section in FIG. 4. In this embodiment, the higher density plate 401 is disposed between a relatively thin lower density layer 403, which serves as the back of the apparatus, and a relatively thick lower density layer 405, which serves as the front of the apparatus. This relatively thick front layer 405 provides for increased capture and retention of the projectiles fired into it due to the increased flowability and pumping of polymer along the path of the projectile, but still provides very effective stopping power due to the density gradient between the outer layer and the higher density core. Moreover, interface 407 provides an effective tumbling zone for accumulation of projectile material during use.

In addition to HMW-HDPE, the polymeric material can contain a number of other components to provide the ballistic apparatus of the invention with desirable properties, including orienting the polymer chains during extrusion, entangling the polymer chains, and providing density gradients within the polymeric material to induce early tumbling or aspect ratio change. Typical compositions include (percentages are by weight based on the total weight of polymeric material):

HMW-HDPE in amounts ranging from about 40% to about 100%;

Maleated HDPE and/or acrylic acid (for adhesion control, in amounts ranging from about 0.25 to about 10%;

Macro and micro fibers, such as silica, alumina, or organic fibers, in amounts ranging from 0 to about 50%, more particularly from about 5 to about 10%;

Peroxide-containing or silane-containing curing agents, in amounts ranging from 0 to about 4%; the material can contain at least two different types of silanes simultaneously, which may each perform independent functions: (1) a curing silane, typically a vinyl silane used with peroxide and catalyst; and (2) a treatment silane, typically of the amino or epoxy types for pigment treatment, to control coupling and melt rheology.

Colorants, in amounts ranging from 0 to about 12%;

Plastomer (for control of crystallinity and curing) in amounts ranging from 0 to about 20% (e.g., ENGAGE 8540 (Dupont Dow); EXXACT 2030 (Exxon), etc.);

Vistalon rubber (for control of crystallinity and to provide entanglement at low temperatures) in amounts ranging from 0 to about 30%;

Natural rubber (desirably in crumb form, to provide elasticity and as a filler) in amounts ranging from 0 to about 25%;

EPDM rubber (desirably in crumb form, to provide low temperature entanglement) in amounts ranging from 0 to about 50%;

Grafting/crosslinking catalyst(s) (such as catalyst T-12, Air Products, Inc.) in amounts ranging from 0 to about 0.5%;

Lubricant (such as a wax or metal stearate, such as zinc stearate) in amounts ranging from 0 to about 12%;

Wetting agent (such as stearic acid) in amounts ranging from 0 to about 4%;

Fillers (such as ceramic (e.g., silica, alumina, and/or zirconia) plates, powders (particularly those having high aspect ratios), and/or spheres) in amounts ranging from 0 to about 30%;

Vulcanization agents (such as sulfur-containing crosslinking compounds) in amounts ranging from 0 to about 8%. It is understood that, when vulcanizing agents are used, zinc oxide and zinc containing derivatives can be included to accelerate the reaction, and magnesium oxide (such as Mag-lite “D” from Merck) can be used to modify and stabilize the vulcanization mechanisms. Additional components can include fire retardants, such as magnesium hydroxide, boric acid, zinc borate, aluminum trihydrate, and various clays including but not limited to montmorillonite, talc, bentonite, and kaolin (nano-clays).

It will be understood that a range of amounts including 0% indicates that the component is optional, and its presence is not necessary to fall within the scope of the invention. It is also understood that various components, such as UV absorption packages (UV absorbers, UV stabilizers, antioxidants, and the like) can be included in the HMW-HDPE as obtained, or may be added separately. Further, blowing agents can be included in amounts appropriate to regulate the density of the polymeric material to desired levels.

Inclusion of rubbers (such as Vistalon, natural rubber, CPE (Chlorinated polyethylene), TPO (thermoplastic polyolefins), TPV (thermoplastic polyolefin vulcanite), or EPDM rubbers) is desirable to provide desirable energy absorption properties at low temperature uses (e.g., in arctic or Antarctic environments). Inclusion of fibers and ceramic fillers helps to provide density changes and initiate tumbling in high temperature uses (e.g, in desert or tropical environments). Inclusion of both types of additives can provide a material suitable for use in a wide range of environments.

The inclusion of maleated HDPE in the composition provides additional adhesion, both to the projectile entering the ballistic apparatus, and of the polymeric material to itself, allowing the extruded polymeric material to be, in effect, hot melt adhered to itself. This allows the material to be formed into a variety of shapes, such as coils or zig-zag shaped plates, wherein the outer surfaces of the extruded tubes of polymeric material will adhere together. This feature also allows for plates of the material to be adhered together by placing them into contact while hot or during heating. The higher density outer skins of the extruded polymer tubes adhere together, creating a thicker higher density region, surrounded by two lower density regions. As the projectile passes through these density gradients, its aspect ratio begins to change.

Various fibers can be added to the material to increase the orientation of the polymer in the flow direction. Fibers were added to the polymer utilizing high speed mixing and/or by an additive feeder so as to control the dispersion of the fiber in the polymer. The fibers used can include one or more of the following: nylon, long and short; carbon, long and short; ceramic (alumina), (silica), (zirconia) and long and short; aramid (chopped, pulped), cellulose-from Kenaf, cotton, wood pulp and wood flour; ground carpet fibers; polyester-fabric; and metal fibers.

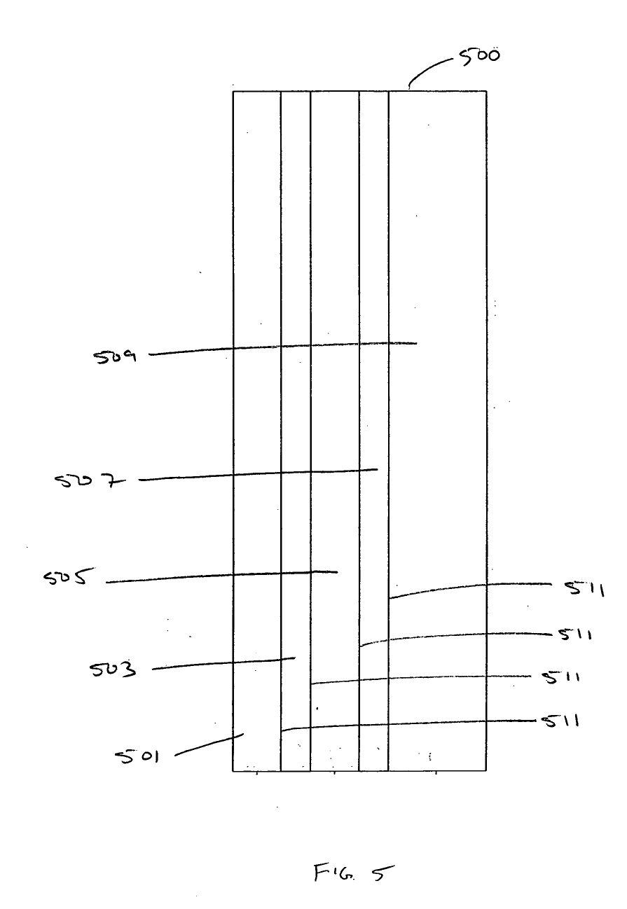

These fibers can be added in differing amounts in different layers of the ballistic apparatus 500 of the invention, as illustrated schematically in FIG. 5. In this embodiment, a first higher density layer 501 is disposed adjacent to a first lower density layer 503, which is in turn disposed adjacent to a second higher density layer 505, which is disposed adjacent to a second lower density layer 507, which is in turn disposed adjacent to a third higher density layer 509. This alternating structure of higher and lower density layers provides several tumbling zone interfaces 511, whose density gradients help promote tumbling, and whose interfaces can expand to accumulate projectile material. The density variations between higher density and lower density layers can be achieved by filling the polymeric material with, e.g., fume silica in the higher density layers, and using unfilled polymeric material in the lower density layers. The higher density layers may be varied in density from each other by including differing amounts of filler. A particularly desirable arrangement is to have the successive higher density layers increase in density along the projected path of the projectile (e.g., layer 509 has a higher density (and higher filler content) than layer 505, which in turn has a higher density than layer 501.

In addition to modifying the composition of the polymeric material, orientation and density gradients can also be affected by the production process itself.

The polymeric material of the invention can be oriented by drawing or extrusion, followed by quench cooling and extending or stretching (which can occur nearly simultaneously). This will generally provide good extension and orientation of the polymer chains without breakage, but with some resistance to the orientation process.

Extrusion parameters, such as the extrusion die or nozzle size and shape, can be varied to optimize results. For example, nozzle size can be varied from around 1.5 inches down to around 0.0625 inch, to more completely force orientation in the extruded flow direction. It has been found that the smaller the diameter of the nozzle, the higher the melt or extrusion temperature has to be in order for the HMW-HDPE to flow as desired. The shape of the nozzle cross section can be varied from circular, to square, to diamond, to oval, to star-shaped, to cross-shaped. For air or polymer injection, various mandrels were developed to be used with the nozzle to complement co-extrusion techniques used in the manufacturing of the final molded product. Examples include tubular mandrels for air injection.

Process parameters relating to cross-linked the HMW-HDPE with small quantities of peroxide and/or silane with tin catalyst increase the molecular weight of the polymeric material by tying up gel polymer, increasing entanglement to flow, and enhancing the bullet capturing ability of the material. The primary objective of modifying these processing parameters is to provide a material that can capture and retain a projectile within the polymer mass within a thickness of two inches or less for low velocity projectiles, and in less than 6 inches for high velocity projectiles, such as bullets from high-powered rifles.

Process parameters directed to controlling density so as to retain the projectile and initiate tumbling or change in aspect ratio include:

a. Controlling pressure in the mold by pressurizing a preheated mold and maintaining it for extended period of time without the pressure destroying the mold. This necessitated pre-design of molds to withstand this extended heating.

b. Introducing gas into the polymer in order to create low-density masses of polymeric material; gas introduction can be accomplished by several methods:
(1) including a blowing agent such as an azo type-blowing agent (e.g., Celogen, Uniroyal), bicarbonate, or other exothermic or endothermic blowing agents. While both types work well, the azo-type blowing agents continue to provide gas injection after the mold had set. This can be dangerous to the mold if the azo adjustments are not balanced properly.
(2) injecting air or other inert gas into a nozzle via a mandrel while the mold is being filled. The mandrel can be made of various shapes, as described earlier. This method has the advantage of adding air when desired, so that density is controlled and varied in specific locations of the polymer mass. Air bubble size is controlled by breaker plate design and/or static mix head for this method.

c. Incorporation of other polymers to increase capturing ability of the polymer as well as controlling density. The polymers can be introduced in a melted state in a similar manner to that used to inject air through the nozzle; however, the polymer injection was done with the use of an auxiliary extruder. Suitable polymers include: polyethylenes having different grades and densities (particularly useful are the current plastomers of PE, such as TPO's, and TPV'S), EPDM, various rubbers, urethane-TPU, urethane, polystyrene, block copolymer of SBS, SEPS, and PP, alpha polyolefins, rubbery epoxies and combinations of these. If fibers are to be added as described above, they may be introduced by being incorporation into any one of the polymers listed to increase bullet capturing ability. Particularly suitable are the urethanes, (one component and two components), typically used for bulletproof windows. These urethanes TPM can be introduced by low pressure in a manner similar to the air injection technique described above, either through a nozzle or injection molding equipment.

d. Fibers can be added in a uniform manner with the controlled dispersion method so that fiber was added to specific regions of the apparatus, depending upon its design. For example, the fiber can be placed in the polymer mass in particular locations to further improve the efficiency of bullet capturing in those regions. The fiber addition was added through the auxiliary extruder via a mandrel in the nozzle where the air was introduced. By dispersing and injecting fiber into polymer and disposing this polymer in certain areas of the ballistic apparatus, the degree of ballistic protection can be increased, even though the ballistic apparatus itself is relatively small or thin. Fiber introduction did not catch on the breaker plates during extrusion, so fiber of various types can be used in chopped or pulped compositions. In order for fibers to be effective in the design they should be matted in the interior zones of the ballistic apparatus The ballistic material of the invention can be made by several techniques, two of which are described below. It will be understood that other, similar techniques can be used to prepare the ballistic material of the invention, such as manipulating the extruded material by hand, etc., and that these are intended to included within the scope of the invention.

I. Injection Molding System:

A mold is designed for the desired shape and configuration. The mold is then injected with polymer at controlled temperature and pressure by delivering the polymer through a standard nozzle or a complex nozzle. The complex nozzle is designed to receive another polymer from an auxiliary extruder to give a co-extrusion extrudate. It is equipped with a mandrel to control the shape and speed of delivery of the co-extruded extrudate. Both extruders are desirably synchronized, so that each extrudate is matched in speed and temperature. Once the mold is filled, the polymer in the mold is pressurized so that the mold is completely filled and the deformation on cooling is minimized. The mold design is fabricated from aluminum or steel, with steel being the preferred material for a clamshell design. Heaters can be installed in the appropriate positions on the mold, and help to promote complete filling of the mold, so that the formation of void spaces is minimized.

Vents may also be installed to permit rapid filling of the mold. The input nozzle is equipped with a pressure-temperature transducer to give the final injection pressure received by the die. The die can desirably be connected by quick disconnect clamps for ease of joining the mold with the extruder and the eventual disconnection of the mold, which is best described as a clamshell mold with clamps.

II Spindle Molding Method:

This provides one method for extruding the polymeric material of the invention into a spiral plate. In this method the polymer is extruded from the nozzle on to a spool where it is wrapped around a spool until it reaches the desired diameter. The spindle is designed with two metal discs with an axle to wrap the extruded prepared polymer. The spindle is powered by a SCR drive controller with torque and speed variable settings. The spindle is equipped with a reel that permits the extrudate to run back and forth on a winding mechanism. The winding mechanism has an eye that spins the extrudate as it passes through it and the reel on its way to the spindle.

Once the spindle is filled with extrudate to the desired level, the spindle is removed from the frame along with the reeling and spinning mechanisms. A steel band can be placed onto the surface of the polymer and wrapped around the outside of the spindle where the polymer is contained by the two discs. The discs act as guides as the polymer is confined in this containment and the heated band completes the final formation of this molding technique. The band is applied and clipped, forcing the polymer to conform to the circular band with this clamp. The result is a solid disc of polymer matrix in the shape of a large disc. The size (thickness and diameter) of the discs may vary; sizes of 30 inches in diameter and 4 to 6 inches thick have been found to be suitable as ballistic apparatus usable as backstop or on firing ranges. The method is suitable for preparation of a wide variety of disc sizes, including very small discs, weighing one pound or less.

Another technique used in manufacturing ballistic apparatus of the invention is to prepare a disc using the spindle method described above, and placing the disc in an injection mold, also described above, and injecting material around the disc. This provides the resulting ballistic apparatus with desirable properties. These enhanced dynamic properties for in-coming projectiles due to the dramatic changes in densities the projectile encounters as it moves from the molded exterior portion to the central disc.

The spiral method described above allows the preparation of multiple laminations of Kevlar or fabric matted composites. The spiraling process allows the incorporation of single or multiple layers of ballistic fabric and/or allows the space between each layer to be filled with the polymer or polymer matrix or foamed polymer, forming a laminate. The laminate can be pressed together to fuse or partially fuse the layers thereof, and can be shaped by a mold or by hand, or in other ways to give a laminate composite with desired shapes or thicknesses, depending on the ballistic requirement. The multiple-laminate method may be done on a horizontal turntable as compared to the reel and spool method described above. The turntable gives the operator more control and increases ease of manufacturing. The center of the spiral can be made without a hollow center core. Finally, the apparatus can be compressed by hydraulic ram to hold it in place in an open mold whether round or square. This containment method shapes the apparatus into a very consistent form. The result is a shape that is reproducible each time the apparatus is made.

In the spiral methods described above, the spiral is tensioned, wrapped and the extrudate from the extruder spun to the desired degree for maximum orientation. The turntable permits ceramic plates, and/or ceramic or metal spheres to be placed in the laminate with the same ease as the placement of fabric or mesh. The objects can all be placed in the spiral matrix to facilitate impediment of any projectiles. The purpose is to force the projectile to tumble, deflect, shatter, mash, or disintegrate in the polymer matrix of ceramic objects, foam or matting. Further, the polymer absorbs energy from whatever the occurring event happens to be. In the case of the ceramic materials, multiple layers can be installed in each layer resulting in a composite that has fabric, polymer or ceramic in combinations that are strictly used to capture the projectile and its respective energy.

Multiple layered laminates of ballistic fabric or mesh are capable of impeding high velocity, high power and high spinning projectiles. The shields will become thinner as composites are developed utilizing higher density in combination with fabric and the high degrees of spiral orientation. The addition of ceramic spheres and/or metal spheres and/or ceramic plates, and/or metal plates or structural fabrications of the same only increases the energy capturing ability. In short, the ceramic or metal structures neutralize higher impulse projectiles with high power, and high spinning masses. The science of capture indicates that high density and the compression ability of the polymer results in a projectile capturing mechanism.

Additional safety features are achieved in a particular embodiment by incorporating foamed polymer in the front, back, and/or sides of the shield having a controlled density so as to prevent bouncing/ricocheting, and/or to control deflection of incoming projectiles. Both flat nosed or blunt projectiles, as well as low velocity projectiles, will deflect off of the surface. Deflections are more likely to occur if the incoming projectile is at a low angle to the material surface. Surface materials having densities ranging from about 0.965 to about 0.40 grams/cc provide and/or allow capture of most incoming projectiles, including most low angle, flat-nosed, and low velocity projectiles, because the projectiles are easily able to penetrate the lower density foamed polymeric material, pump molten polymer behind them into their path, and creating an opening smaller than the projectile's aspect ratio. The low density polymeric material thus limits or prevents backward movement of the projectile after contacting, e.g., a more dense portion of the apparatus. This allows the projectile to be captured, so that they cannot bounce back out of the apparatus.

As described above, the density of the polymeric material can be controlled by several methods. In producing lower density foamed polymeric material for a surface layer, density may be controlled by adding a low-density polymer to the HMW-HDPE composition to lower the overall density into the desired range. Alternatively or additionally, very precise additions of closed cell blowing agents can be incorporated in the polymer matrix to lower the density to the desired values. These methods provide reproducible densities during production of the material and apparatus. The layer of this controlled/lower density polymer will typically have a thickness of between about 0.25 and 6 inches, depending on the designed purpose of the apparatus. Thicker layers will typically be used on apparatus intended to capture higher velocity projectiles, or projectiles likely to impact at very low angles. Thinner layers may be suitable for use in apparatus intended to capture lower velocity projectiles, such as handgun rounds, etc. Because the controlled/lower density polymeric material is a closed cell foam, there are few or no voids in the matrix.

By using a lower density layer in conjunction with a higher density polymeric material, the resulting apparatus provides for multiple density differentials (both between the surface and inner portion of the polymeric material, and between the higher density and lower density materials) that cause projectiles to “tumble” (i.e., to change their aspect ratio sufficiently that a substantial portion of their kinetic energy is captured by the apparatus, along with the projectile. The lower density polymeric material acts as a sort of “ricochet net”. If not melted to the surface of an inner, higher density polymeric material, the gap between the layers can allow a place for the projectile material to accumulate. Because the accumulation of projectile material spreads out in the gap between polymeric material layers, it provides a further barrier to penetration by additional incoming projectiles. The apparatus is thus not compromised by the impact of additional in-bound rounds, so it is virtually impossible to “shoot through” the apparatus. In addition, the retention of projectile material, often mostly or almost entirely lead, prevents or limits the release of particles of projectile material into the environment.

The ballistic apparatus of the invention can be formed from unbonded layers of spiraled extruded polymeric material to capture and accumulate projectiles when the entire shield is composed of high density composite. The unbonded layers allow formation of “tumble zones” that slow and stop projectiles after tumbling, and provide a place for projectile material to accumulate. Ballistic apparatus designed in this way is particularly suitable for high velocity projectiles and/or projectiles exhibiting a high rate of spin, such as rifle rounds.

Additional closed cell foam methods have been developed to extrude tubules having a hollow inner area that can be filled with air or high density polymers. Incorporating air provides a foam that is not active after air is entrapped and is independent of temperature. The cells are clean, since they contain only air at atmospheric pressure.

This method also allows densities greater than the base polymer, HMW-HDPE. When the tube is filled with urethane, as an example, its density is greater than 9.965 g/cc.

The polymeric material used to make the ballistic apparatus of the invention may be filled with ceramic materials as described above. As used herein, the term “ceramic” can include, but is not limited to, materials made from zirconia, alumina, borates, and/or silica. The ceramics may be sintered (e.g., fired in a kiln to develop their grain size) or unsintered. They may be shaped into desired forms, e.g., spheres, plates and/or very fine to coarse beads. Examples of silicas include glass, noveculite, quartz, sand, each having various particle sizes, and combinations of these. Ceramics made from cements of silica, Portland cement, alumina cements, magnesium oxide cements, phosphorate cements, and/or hydrocements are especially good and very economical. They have compression values of 15,000 to 60,000 psi without sintering in a kiln. These ceramic cements can combined with the polymeric material of the invention and can then be shaped from a liquid and poured into a void, which forms a mold for the apparatus of the invention. They may be pre-formed into plates, spheres or any other desired shape with the resulting material having the approximate hardness of sintered ceramic. Polymer ceramic cement versions used are so flexible they can stop projectiles without shattering completely.

The inclusion of ceramic elements in the polymeric material according to the invention enhances the utility of the resulting ballistic material as armor, in part because of the ability of the polymer to disperse energy prior to and after impact of the projectile with the ceramic element, thereby making the entire composite more efficient. Polymer cements (e.g., those including polymethylmethacrylate, polyacrylates, polystyrene and copolymers thereof (such as polybutylacrylate, poly-2-ethylhexylacrylate, copolymers such as polystyrenemethylmethacrylate, SBR rubber), and the like) can also be used in the invention.

### METHODS OF USING THE POLYMERIC MATERIAL OF THE INVENTION

The energy absorbing polymeric material of the invention, and apparatus made from it, can be used in a number of applications. These include:
1. Ballistic shields (e.g., hand held) for military and law enforcement use.
2. Ballistic armor for military vehicles, particularly for protecting tracks, radiators, engines, personnel and other vulnerable areas
3. Ballistic armor components for aircraft, particularly for protecting pilot compartments, avionics packages, hydraulic systems, ejection systems, fuel systems, engine housings, etc.
4. Bullet capturing targets for sport and training, either as individual targets or complete walls; particularly suitable for tactical training targets for military and law enforcement use.
5. Ballistic armor for mobile support facilities, such as mobile military command and control posts, communications installations, surgical hospitals, evac stations, etc.
6. Dock bumpers for trucks and large ships.
7. Shock absorber in pads for building columns.
8. Shields or plates forming part of tactical law enforcement or military body armor, particularly with embedded ceramic, Kevlar or nylon mailing.
9. Armored doors, panels etc. for armored trucks, bank vaults and other secure locations.
10. Protective pads for all sports activities in foam and high density layers to make composites that have multiple low and high density laminates.
11. Containment devices for bombs, unexploded ordinance, improvised explosive devices (I.E.D).
12. Other applications where energy and impact absorption, light weight, compact size, and/or reuse are important.
13. Apparatus can be used for the protection of spacecraft and space personnel from flying shrapnel and solid particles since apparatus is fully vulcanized.

The invention can be more clearly understood by reference to the following examples, which are not intended to be limiting of the appended claims.

### EXAMPLE 1

60 lb of HMW-HDPE (obtained as a reground HMW-HDPE waste stream containing EVOH (ethylene vinyl alcohol polymer) were combined with 0.6 lb of AMPLIFY 204 (Dow) and 0.3 lb of B.A. CELOGEN (50%) (Uniroyal) and mixed in a high intensity mixer and in an extruder at a temperature of about 400 to 450° F. The composition was extruded through a round, 1 inch diameter conical nozzle to form a tube approximately 1.5-2 inches in diameter. This tube was formed into a flattened spiral by coiling in a heated mold plate. The extruded material had a density of approximately 0.96 g/cm³.

### EXAMPLE 2

A handgun/shotgun target apparatus was prepared by allowing the double thickness spiral material obtained in Example 2 to cool. The identical composition was prepared, except that 0.75 wt % of azo blowing agent (Bergen Intl.) FOAMAZOL 50 or FOAMAZOL 81 was added; the composition was introduced into the extruder described in Example 1, and a 4 inch thick spiral layer of material having density of about 0.37 g/cm³ was extruded onto a heated mold plate. The cooled double thickness spiral was disposed onto this layer while the layer was still hot, and additional polymeric material was extruded around the edge of the double thickness material. Finally, another 4 inch thick spiral layer was extruded on top of the double thickness layer. The resulting material was removed from the mold plate and allowed to cool, forming a composite structure containing a central hard plate of higher density, and a surrounding foam layer of lower density.

### EXAMPLE 3

A rifle target was prepared by repeating the process of Example 1, with the modification that another polymeric material containing fumed silica was included in the apparatus. The target was formed by cold laminating: a first layer having a thickness of 2 inches and having a silica content of 16.66 wt % and a density of 1.17 g/cm³; a second layer having a thickness of 1.25 inches, a density of 0.870 g/cm³ and without fumed silica, a third layer having a thickness of 2 inches and a silica content of 23.78 wt % and a density of 1.26 g/cm³, a fourth layer having a thickness of 1.25 inches, a density of 0.870 g/cm³, and without silica, and a fifth layer having a thickness of 4 inches, a silica content of 42.85 wt %, and a density of 1.499 g/cm³.

### EXAMPLE 4

A ballistic apparatus made by the process described in Example 2 was subjected to intensive ballistic testing by firing over 7000 rounds of various calibers into it. This testing included firing 800 Makarov rounds, 2000.40 cal. rounds, 250.357 cal. rounds, 2500 9 mm rounds, 25 .50 cal. Rounds, 300 Tokarev rounds, 75 .25 cal. rounds, 100 12 gauge rifled slugs, 100 rounds of 00 gauge buckshot, 25 12 gauge sabot slugs, and 900 .45 cal. rounds, from a distance of about 3 ft, without any penetration through the target. The 100 12 gauge rifled slugs were fired into an area approximately 10 cm in diameter without failure of the ballistic material (i.e., all rounds were trapped and retained within the apparatus.

### EXAMPLE 5

A ballistic apparatus made by the process described in Example 3 was subjected to ballistic testing by firing over 7000 rounds into the target, including 1800 rounds of AR-15 .223 cal., 2000 rounds of AR-15 .223 SS109, 3000 rounds of AK-47 7.62 mm, 180 rounds of .306 cal. FMJ, 25 rounds of 7 mm Magnum, and 60 rounds of .308 Power Point from a distance of approximately 3 ft. No penetration through the target was observed.

The ballistic apparatus prepared and tested above demonstrate the significant advantages of the invention. As rounds are fired into a conventional ballistic material, repeated projectile strikes in the same general area often results in failure of the material. In fact, for ceramic armor, a single projectile strike will render the struck armor plate useless, and require it to be replaced. This can be problematic in the heat of combat. By stark contrast, the ballistic material of the invention actually improves its stopping performance as projectiles are fired into it, because the accumulation of spent projectile material actually collects at about the same depth in the material, forming a plate of spent projectile material that helps to stop additional incoming projectiles. Thus, repeated firing into the same general region of the material in the hopes of eventually penetrating it has the opposite effect. As an example, an enemy combatant who repeatedly fires at the driver's compartment of an armored vehicle, or the cockpit of a helicopter gunship, in the hopes of disabling or killing the driver or pilot, actually renders the individual under attack safer.

What is claimed is:

1. A ballistic apparatus comprising:
a polymeric material comprising a high molecular weight, high density polyethylene.

2. The ballistic apparatus of claim 1, wherein the polymeric material comprises at least one first region having a first density and at least one second region having a second density different from the first density.

3. The ballistic apparatus of claim 2, wherein the first and second regions are substantially along a path of a projectile fired at the apparatus.

4. The ballistic apparatus of claim 3, comprising:
(a) a relatively flat core of polymeric material having a first density, disposed within:
(b) a relatively flat shell of polymeric material having a second density, wherein the first density is higher than the second density.

5. The ballistic apparatus of claim 4, wherein the core comprises fused tubes of extruded polymeric material.

6. The ballistic apparatus of claim 4, wherein the shell comprises fused tubes of extruded polymeric material.

7. The ballistic apparatus of claim 4, further comprising a tumble zone disposed between the core and the shell, adapted to accumulate material from spent projectiles.

8. The ballistic apparatus of claim 1, wherein the polymeric material further comprises maleated high density polyethylene.

9. The ballistic apparatus of claim 1, wherein the polymeric material further comprises an inorganic fiber, sphere, or plate, comprising a metallic material, a ceramic material, or a combination thereof.

10. The ballistic apparatus of claim 9, wherein the inorganic fiber, sphere or plate comprises silica fibers.

11. The ballistic apparatus of claim 9, wherein the inorganic fiber, sphere or plate comprises metallic fibers.

12. The ballistic apparatus of claim 9, wherein inorganic fiber, sphere, or plate provides internal support to the apparatus.

13. The ballistic apparatus of claim 1, wherein the polymeric material further comprises TPO elastomers, TPV elastomers, or combinations thereof.

14. The ballistic material of claim 13, wherein the elastomer is selected from the group consisting of natural rubber, EPDM rubber, CPE (Chlorinated polyethylene), TPO, TPV, and combinations thereof.

15. The ballistic apparatus of claim 2, wherein the polymeric material further comprises an inorganic fiber, sphere, or plate, and an elastomer.

16. The ballistic apparatus of claim 15, wherein the inorganic fiber, sphere, or plate comprises a metallic fiber, a ceramic fiber, or a combination thereof.

17. The ballistic apparatus of claim 16, wherein the inorganic fiber, sphere or plate comprises silica fibers and the elastomer is selected from the group consisting of natural rubber, EPDM rubber, CPE (Chlorinated polyethylene), TPO, TPV and combinations thereof.

18. The ballistic apparatus of claim 17, wherein the material is fully vulcanized materials.

19. The ballistic apparatus of claim 1, wherein the ballistic apparatus is a firearm backstop.

20. The ballistic apparatus of claim 1, wherein the ballistic apparatus is protective ballistic armor.

21. A method of protecting a structure from ballistic impact, comprising disposing adjacent to the structure the ballistic apparatus of claim 1.

22. The method of claim 21, wherein the structure is selected from the group consisting of personnel, building structures, ground vehicles, aircraft, spacecraft, ships, and pipelines.
